(19) United States
(12) Patent Application Publication
(10) Pub. No.: US 2018/0223544 A1
(43) Pub. Date: Aug. 9, 2018

(54) FLOOR UNDERLAYMENT SHEETS, FLOOR UNDERLAYMENT SYSTEMS AND RELATED METHODS

(71) Applicant: Automated Solutions, LLC, Sawmills, NC (US)

(72) Inventors: Robert L. Campbell, Hickory, NC (US); Richard C. Boyd, Hickory, NC (US)

(73) Assignee: Automated Solutions, LLC, Sawmills, NC (US)

(21) Appl. No.: 15/821,410

(22) Filed: Nov. 22, 2017

Related U.S. Application Data
(60) Provisional application No. 62/425,072, filed on Nov. 22, 2016.

(51) Int. Cl. E04F 15/18; B32B 3/06; B32B 5/32

(52) U.S. Cl. CPC E04F 15/187; B32B 3/06; B32B 2419/04; B32B 2266/025; B32B 5/32

(57) ABSTRACT

Floor underlayments, floor underlayment systems and related methods are provided herein. A floor underlayment sheet can include a middle body portion having first outer face and a second outer face with the middle body portion having a thickness. The floor underlayment sheet can also include a first end portion extending outward from the middle body portion from a first side of the middle body portion. The first end portion can have an outer face that aligns with and is contiguous with the first outer face of the middle body portion and an inner face that is opposite the first end portion outer face. The floor underlayment sheet can further include a second and portion extending outward from the middle body portion from a second side of the middle body portion. The second end portion can have an outer face that aligns with and is contiguous with the second outer face of the middle body portion and an inner face that is opposite the second end portion outer face. The first end portion and the second end portion can have thicknesses that are a fraction of the thickness of the middle body portion.

### RELATED APPLICATION

The presently disclosed subject matter claims the benefit of U.S. Provisional Patent Application Ser. No. 62/425,072, filed Nov. 22, 2016, the disclosure of which is incorporated herein by reference in its entirety.

### TECHNICAL FIELD

The present subject matter relates to floor underlayments, floor underlayment systems and related methods in particular the present subject matter relates to foam underlayments used under finish flooring, such as hardwood flooring, laminate flooring, or the like, so that the floor underlayment is placed between a finished flooring and a subflooring.

### BACKGROUND

Generally speaking, the floor system in a building can comprise a subflooring and a finished flooring. Often a wood or steel joist can support both the subflooring and the finished flooring in a wood floor system. The subflooring is often (e.g., one-inch thick) softwood or hardwood boards or plywood panels. The finished flooring is typically thinner and often is hardwood boards. Wood floor systems are usually used in residences or apartments. The floor system in steel-framed buildings is typically supported by open-web steel bar joists or steel beams. The floor deck or subflooring on the bar joists or beams can be, for example, a steel deck, a precast concrete stab or panels, or a precast hollow-core concrete slab or panels.

In some multi-floor buildings, the floor system can be a reinforced-concrete floor system. Such a reinforced-concrete floor system is commonly constructed in a monolithic manner with the structural framing system. In such floor systems, the reinforced-concrete subflooring can be flat-slab construction (reinforced in two directions, for example, by rebar), flat-plate construction or slab-band construction.

The floor finish or wearing surface is located over the wood, steel or concrete subfloor. The floor finish can be wood, laminate tiles, resilient tires or a laminate sheet. The wood floor finish can be softwood or hardwood—usually oak, yellow pine or maple can be used. The shapes and finishes of the wood floor finish can be a variety of different shapes and styles, for example, but not limited to matched flooring, plank-finished flooring, parquet flooring, wood-block flooring, or the like. The resilient flooring can be linoleum, asphalt tile, or vinyl or rubber tile or sheet. However, laying wood flooring and certain tile and sheet flooring directly onto subflooring can result in a floor which has essentially no resiliency. People walking and standing on such floors often have tired and stressed feet, legs, knees, backs, etc., plus they sometimes suffer damage to their feet, knees, etc., particularly over extended and repetitive periods of standing or walking.

To combat the lack of resiliency, some installers use a polyethylene foam with a thin layer of polyethylene film thereon installed on subflooring, followed by placing a finished flooring on top of the polyethylene foam sheet layer. The polyethylene foam sheet can be useful in taking out small irregularities in the top surface of the concrete. The polyethylene foam sheet can also provide some sound reduction. Further, slight cushioning is provided by the polyethylene foam sheet to alleviate the problems suffered by persons walking and standing on such floors. When installing the polyethylene foam over the subflooring, sheets of the polyethylene foam are unrolled in the form of long strips onto the subflooring. The installer aligns two foam strips and then tapes the facing edges together, then lays another foam strip and goes through the taping operation of taping the next two edges together, and so on. Due to the speed of laying this underlayment and tediousness of ensuring alignment, the aligning of the foam along the edges can often lead to gaps between the edges of the underlayment where no cushioning is provided or undesirable thick spots where the edges unintentionally overlap.

As such, a need exists for improved floor underlayments and floor underlayment systems that an facilitate quick installment while reducing gaps and unwanted thick spots in the underlayment between the finishing floor and the subflooring.

### SUMMARY

The present subject matter provides floor underlayments, floor underlayment systems and related methods. In particular, foam underlayments used under finish flooring, such as hardwood flooring, laminate flooring, or the like, so that the floor underlayment is placed between a finish flooring and a subflooring. Methods related to the manufacture and use of the floor underlayments and floor underlayment systems herein are also provided.

Thus, it is an object of the presently disclosed subject matter to provide floor underlayments and floor underlayment systems that can reduce gaps and unwanted thick spots in the underlayment between the finished floor and the subflooring. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a schematic side plan view of an embodiment of a sheet of underlayment according to the present subject matter;

FIG. 2 illustrates a perspective view of an embodiment of a system of underlayments placed between the finished flooring and a subflooring according to the present subject matter; and

FIG. 3 illustrates a respective schematic side plan view of the embodiment of the floor underlayment system according to the present subject matter.

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer or section. Thus, a first feature, element component, region, layer or section discussed below could be termed a second feature, element, component, region, layer or section without departing from the teachings of the disclosure herein.

Similarly, when a layer or coating is being described in the present disclosure as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well m ranges within the limit, such as from about 1 to about 5, and from about 3.2 to about 6.5 as examples.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

The term “thermoplastic” is used herein to mean any material formed from a polymer which softens and flows when heated; such a polymer may be heated and softened a number of times without suffering any basic alteration in characteristics, provided heating is below the decomposition temperature of the polymer. Examples of thermoplastic polymers include, by way of illustration only, polyolefins, polyesters, polyamides, polyurethanes, acrylic ester polymers and copolymers, polyvinyl chloride, polyvinyl acetate, etc. and copolymers thereof.

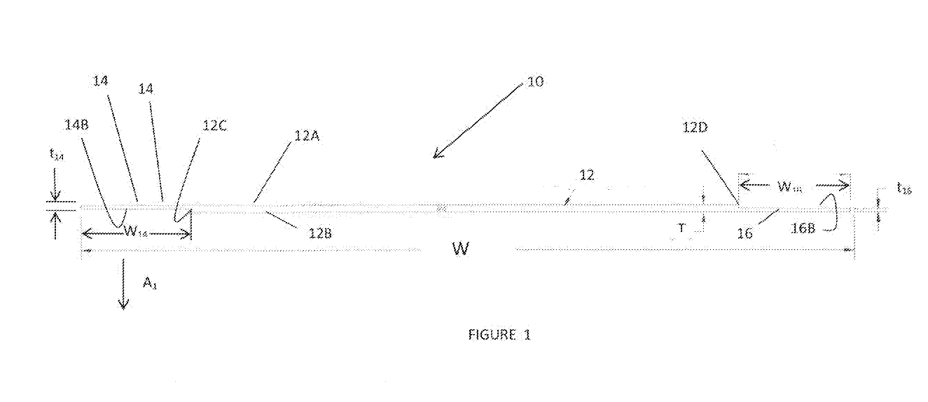

Referring to FIG. 1, a side view of an embodiment of a floor underlayment sheet 10 is provided. The floor underlayment sheet 10 can comprise a middle body portion 12 having first outer face 12A and a second outer face 12B. In some embodiments, the middle body portion 12 can generally have a uniform thickness T. The floor underlayment sheet 10 can comprise a first end portion 14 that can extend outward from the middle body portion 12 from a first side 12C of the middle body portion 12, the first end portion 14 can have an outer face portion 14A that aligns with and is contiguous with the first outer face 12A of middle body portion 12 and an inner face 14B that is opposite the first end portion outer face 14A. The first end portion 14 can have a thickness t₁₄ that is a fraction of the thickness T of the middle body portion 12. Similarly, the floor underlayment sheet 10 can comprise a second end portion 16 that can extend outward from the middle body portion 12 from a second side 12D of the middle body portion 12. The second end portion 16 can have an outer face 16A that aligns with and is contiguous with the second outer face 12B of the middle body portion 12 and an inner face 16B that is opposite the second end portion outer face 16A. The second end portion 16 can have a thickness t₁₆ that is also a fraction of the thickness T of the middle body portion 12. In some embodiments, the inner face 14B of the first end portion 14 faces in a first direction A₁ and the inner face 16B of second end portion 16 faces in an opposite second direction B₁.

A plurality of the floor underlayment sheets 10 can be laid down on a subflooring of a building so that the first end portion 14 of a underlayment sheet overlays the second end portion 16 of an adjacent floor underlayment sheet. Thereby, the adjacent floor underlayment sheets 10 can be quickly secured together with no gaps between the adjacent floor underlayment sheets 10 and no thick spots where middle body portions 12 overlap. Each of the floor underlayment sheet 10 can comprise comprises a polymer material. For example, each of the floor underlayment sheets 10 can comprise a thermoplastic polymer. For instance, in some embodiments, each of the floor underlayment sheets 10 can comprise a thermoplastic foam. In particular, in some embodiments, each of the floor underlayment sheets 10 can comprise a polyethylene foam. In some such embodiments, the polyethylene foam can have a density of between about 0.8 lbs./ft.³ and about 4 lbs./ft.³.

Generally speaking, in some embodiments, the thickness t₁₄, t₁₆ of the first and second end portions 14, 16 can comprise about one half (½) the thickness T of the middle body portion 12. For example, in some embodiments, the thickness T of the middle body portion 12 can be between about one-eighth (⅛) of an inch and about one-fourth (¼) of an inch. In some such embodiments, the thickness t₁₄, t₁₆ of the first and second end portions 14, 16 can be between about one sixteenth ( 1/16) of an inch and about one-eighth (⅛) of an inch.

In some embodiments, the floor underlayment sheet 10 comprises a foam body with the floor underlayment sheet being formed by cutting the foam body to form the middle body portion 12 and the first and second end portions 14, 16. In some embodiments, the floor underlayment sheet 10 can comprise a foam body with the floor underlayment sheet 10 being formed by grinding the foam body to form the middle body portion 12 and the first and second end portions 14, 16. In some embodiments, the floor underlayment sheet can comprise a foam body with the floor underlayment sheet 10 being formed by sanding the foam body to form the middle body portion 12 and the first and second end portions 14, 16. As stated above, the inner face 14B of the first end portion 14 can face in a first direction A₁ and the inner face 16B of second end portion 16 can face in an opposite second direction B₁.

In some embodiments, the floor underlayment sheet 10 can comprise a width W that can be between about thirty-six (36) inches and about ninety-six (98) inches. In some embodiments, the floor underlayment sheet 10 can comprise a width W that can be between about forty-eight (48) inches and about ninety-six (96) inches. In some such embodiments, widths w₁₄, w₁₆ of the first and second end portions 14, 16 can be about equal, i.e., about the same in measurement. In some such embodiments, widths w₁₄, w₁₆ of the first and second end portions 14, 16 can be between about a half (0.5) inch and about two (2) inches. In some such embodiments, widths w₁₄, w₁₆ of the first and second end portions 14, 16 can be between about a one and half (1.5) inches and about two (2) inches. In general, in some embodiments, the width w₁₄, w₁₆ of the first and second end portions 14, 16 can be about ten (10) percent or less of the total width W of the floor underlayment sheet 10. In some embodiments. In some such embodiments, widths w₁₄, w₁₆ of the first and second end portions 14, 16 can be about five (5) percent or less of the total width of the underlayment sheet. In some such embodiments, widths w₁₄, w₁₆ of the first and second end portions 14, 16 can be about three (2) percent or less of the total width of the underlayment sheet.

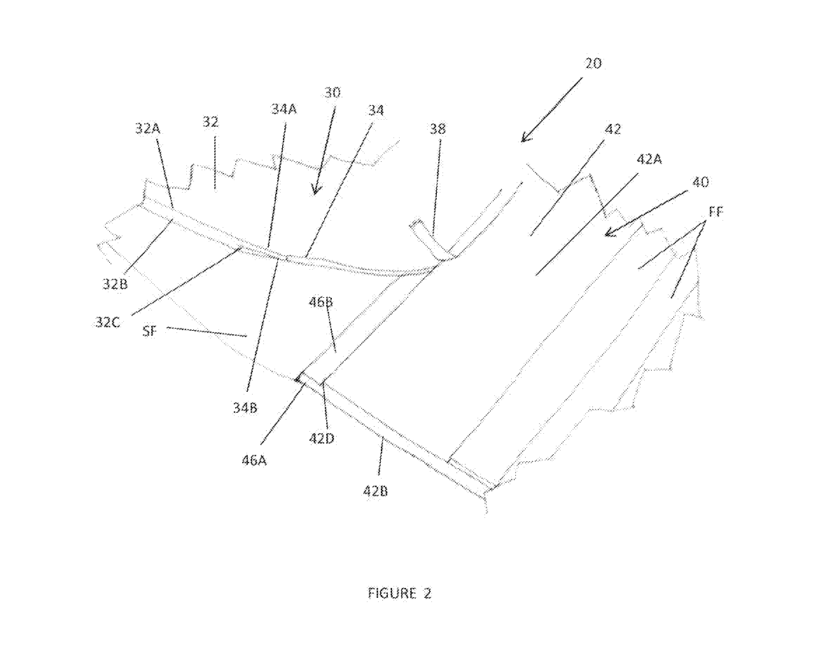

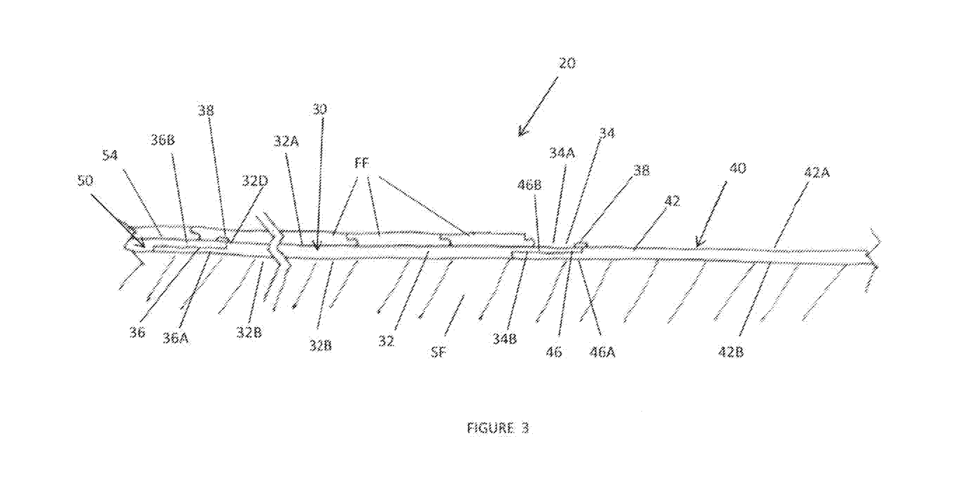

FIGS. 2 and 3 partially show an embodiment of a floor underlayment system 20 including sheets 30, 40 of underlayment for securement between a finished flooring FF and a subflooring SF. Each of the plurality of floor underlayment sheets 30, 40 can comprise a middle body portion 32, 42 that can have a first outer face 32A, 42A and a second outer face 32B, 42B. Each of the middle body portions 32, 42 can generally have a uniform thickness as described above. Each of the plurality of floor underlayment sheets 30, 40 can also comprise a first end portion (34 on sheet 30, not shown on sheet 40 in FIGS. 2 and 3) extending outward from the middle body portion 32, 42 from a first side (32C on sheet 30, not shown on sheet 40 in FIGS. 2 and 3) of the middle body portion 32, 42. The first end portion 34 as shown on sheet 30 can have an outer face 34A that can align with and can be contiguous with the first outer face 32A of the middle body portion 32 and an inner face 34B that is opposite the first end portion outer face 34A. As stated above, the first end portions of the sheets 30, 40 can have a thickness that is a fraction of the thickness of the respective middle body portions 32, 42. Additionally, each of the plurality of floor underlayment sheets 30, 40 can comprise a second end portion 36, 46 that can extend outward from the middle body portion 32, 42 from a second side 32D, 42D of the middle body portion 32, 42. The second end portions 36, 46 can each have an outer face 36A, 46A that can be aligned with and is contiguous with the respective second outer face 32B, 42B of the middle body portion 32, 42 and an inner face 36B, 46B that is opposite the second end portion outer face 36A, 46A with the second end portions 36, 46 having a thickness that is a fraction of the thickness of the middle body portion 32, 42.

For example, once the floor underlayment sheet 40 is placed on the subfloor SF with the outer face 46A of the second end portion 46 and the second outer face 42B of the middle body portion 42 residing against the subfloor SF with the inner face 46B of the second end portion 46 facing upward, the floor underlayment sheet 30 can be placed on the subfloor SF. In particular, the first end portion 34 of the floor underlayment sheet 30 can be placed over the second end portion 46 of the floor underlayment sheet 40 such that the inner face 34B of the first end portion 34 of the floor underlayment sheet 30 faces and is positioned on top of inner face 46B of the second end portion of the floor underlayment sheet 30 with the outer face 34A of the first end portion 34 of the floor underlayment sheet 30 and the first outer face 42A of the middle body portion 42 face upward. The width of the first end portion 34 of the floor underlayment sheet 30 can be substantially equal to the width of the second end portion 46 of the floor underlayment sheet 40. Thereby, during placement of the underlayment sheet 30 on the subfloor SF, a proper alignment of the underlayment sheets 30, 40 can be quickly and easily achieved due to the substantially equal widths of the first end portion 34 of the floor underlayment sheet 30 and the second end portion 46 of the floor underlayment sheet 40 with the side 42D of the middle body portion 42 generally abutting the end of the first end portion 34 of the first underlayment sheet 30 and the side 32C of the middle body portion 32 generally abutting the end of the second end portion 44 of the second underlayment sheet 40. In this manner, undesirable double overlap of the body portions 32, 42 of the underlayment sheets 30, 40 and void spaces where no abutment or overlap occurs can be avoided. In particular, the use of the underlayment system 20 can be more quickly, easily and accurately laid than traditional foam sheets without such first and second end portions of the underlayment sheet embodiments described above.

The floor underlayment sheets 30, 40 can be secured together in a variety of ways. For example, in some embodiments, the floor underlayment system 20 can comprise tape 38 for securing the first end portion 34 or the first underlayment sheet 30 over the second end portion 46 of the second underlayment sheet 40. As shown in FIGS. 2 and 3, tape 38 can be used to secure the first end portion 34 of the first underlayment sheet 30 to the middle body portion 42B of the second underlayment sheet 40 to secure the underlayment sheet 30, 40 together and to hold the first end portion 34 over the second end portion 46. In some embodiments, a tape with a peelable liner may be secured to the either the inner face 34B of the first end portion 34 of the first underlayment sheet 30 or to the inner face 46B of the second end portion 46. In such embodiments, the peelable liner can be removed and the first end portion 34 pressed against the second end portion 46 to secure a first end portion 34 of a first underlayment sheet 30 to a second end portion 46 of a second underlayment sheet 40. In some embodiments, an adhesive can be used for securing a first end portion of a first underlayment sheet over a second end portion of a second underlayment sheet. For example, an adhesive may be applied to the either the inner face 34B of the first end portion 34 of the first underlayment sheet 30 or to the inner face 46B of the second end portion 46 of the second underlayment sheet 40. In such embodiments, the first end portion 34 can be pressed against the second end portion 46 to secure a first end portion 34 of a first underlayment sheet 30 to a second end portion 46 of a second underlayment sheet 40 of the second underlayment sheet 40. In some embodiments, a cold seal adhesive can be used, the components of which can be applied to the first end portion 34 of the first underlayment sheet 30 over the second end portion 46 of the second underlayment sheet 40.

As shown in FIG. 3, if needed, a third underlayment sheet 50 have the same or similar construction as the underlayment sheets 30, 40 can be used such that a first end portion 54 of the third underlayment sheet 50 can be placed over the second end portion 36 of the first underlayment sheet 30 with the end portion 32D of the first underlayment sheet 30 generally abutting the end of the first end portion 54 of the floor underlayment sheet 50. As above, tape 38 can be used to secure the first end portion 54 of the third underlayment sheet 50 over the second end portion 36 of the first underlayment sheet 30. Thereby, the number of underlayment sheets used can be easily varied depending on the size of the room and the width of the underlayment sheets.

Once the floor underlayment sheets 30, 40 are laid on the subfloor SF, the finished flooring FF can be placed on the secured floor underlayment sheets 30, 40, 50 as shown FIGS. 2 and 3.

As disclosed herein, a method of laying the floor underlayment is provided as described above. Further, a method of making floor underlayment sheet can comprise providing a sheet of a resilient polymer. The polymer can be a thermoplastic polymer. For instance, in some embodiments, the polymer can comprise a thermoplastic foam. In particular, in some embodiments, polymer can comprise a polyethylene foam. In some such embodiments, the polyethylene foam can have a density of between about 0.8 lbs./ft.³ and about 4 lbs./ft.³. A first end portion in the sheet of the resilient polymer can be formed extending outward from a middle body portion of the sheet of the resilient polymer from a first side of the middle body portion. The first end portion can have an outer face portion that aligns with and is contiguous with a first outer face of the middle body portion and an inner face that is opposite the first end portion outer face. The first end portion can have a thickness that is a fraction of a thickness of the middle body portion. Similarly, a second end portion in the sheet of the resilient polymer can be formed extending outward from the middle body portion of the sheet of the resilient polymer from a second side of the middle body portion. The second end portion can have an outer face portion that aligns with and is contiguous with a second outer face of the middle body portion and an inner face that is opposite the second end portion outer face. The second end portion can also have a thickness that is a fraction of the thickness of the middle body portion.

In some embodiments, the steps of forming the first and second end portions in the sheet of the resilient polymer can comprise cutting the sheet of the resilient polymer to form the first end portion and the second end portion. In some embodiments, the steps of forming the first and second end portions in the sheet of the resilient polymer can comprise grinding the sheet of the resilient polymer to form the first end portion and the second end portion. In some embodiments, the steps of forming the first and second end portions in the sheet of the resilient polymer can comprise sanding the sheet of the resilient polymer to form the first end portion and the second end portion.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole or in part. Furthermore, those of ordinary skill in the art will appreciate that the foregoing description is by way of example only, and is not intended to limit the present subject matter.

1. A floor underlayment sheet comprising:
a middle body portion having first outer face and a second outer face, the middle body portion having a thickness;
a first end portion extending outward from the middle body portion from a first side of the middle body portion, the first end portion having an outer face that aligns with and is contiguous with the first outer face of the middle body portion and an inner face that is opposite the first end portion outer face, the first end portion having a thickness that is a fraction of the thickness of the middle body portion; and
a second end portion extending outward from the middle body portion from a second side of the middle body portion, the second end portion having an outer face that aligns with and is contiguous with the second outer face of the middle body portion and an inner face that is opposite the second end portion outer face, the second end portion having a thickness that is a fraction of the thickness of the middle body portion.

2. The floor underlayment sheet as in claim 1, wherein the floor underlayment sheet comprises a polymer material.

3-4. (canceled)

5. The floor underlayment sheet as in claim 1, wherein the floor underlayment sheet comprises a polyethylene foam.

6. The floor underlayment sheet as in claim 5, wherein the polyethylene foam has a density of between about 0.8 lbs./ft.3 and about 4 lbs./ft.3.

7. The floor underlayment sheet as in claim 1, wherein the thickness the middle body portion comprises between about one-eighth (⅛) of an inch and about one-fourth (¼) of an inch.

8. (canceled)

9. The floor underlayment sheet as in claim 1, wherein the thickness of the first and second end portions comprise about one half (½) of the thickness of the middle body portion.

10-12. (canceled)

13. The floor underlayment sheet as in claim 1, wherein the inner face of the first end portion faces in a first direction and the inner face of second end portion faces in an opposite second direction.

14. The floor underlayment sheet as in claim 1, wherein the width of the floor underlayment sheet is between about thirty-six (36) inches and about ninety-six (96) inches.

15. (canceled)

16. The floor underlayment sheet as in claim 1, wherein the width of the first and second end portions is between about a half (0.5) inch and about two (2) inches.

17. (canceled)

18. The floor underlayment sheet as in claim 1, wherein the width of the first and second end portions is about ten (10) percent or less of the total width of the floor underlayment sheet.

19. (canceled)

20. The floor underlayment sheet as in claim 1, wherein the thickness of the middle body portion is a generally uniform thickness.

21. A floor underlayment system for securing sheets of floor underlayment between a finished flooring and a subflooring, the system comprising:
two or more floor underlayment sheets, each of the floor underlayment sheets comprising:
a middle body portion having first outer face and a second outer face, the middle body portion generally having a uniform thickness;
a first end portion extending outward from the middle body portion from a first side of the middle body portion, the first end portion having an outer face portion that aligns with and is contiguous with the first outer face of the middle body portion and an inner face that is opposite the first end portion outer face, the first end portion having a thickness that is a fraction of the thickness of the middle body portion; and
a second end portion extending outward from the middle body portion from a second side of the middle body portion, the second end portion having an outer face portion that aligns with and is contiguous with the second outer face of the middle body portion and an inner face that is opposite the second end portion outer face, the second end portion having a thickness that is a fraction of the thickness of the middle body portion; and
wherein the first end portion of one of the underlayment sheets is positioned over a second end portion of another of the underlayment sheets to form an underlayment for a finished flooring.

22. The floor underlayment system as in claim 21, further comprising tape for securing a first end portion of a first underlayment sheet over a second end portion of a second underlayment sheet.

23. The floor underlayment system as in claim 21, further comprising adhesive for securing a first end portion of a first underlayment sheet over a second end portion of a second underlayment sheet.

24-30. (canceled)

31. The floor underlayment system as in claim 21, wherein the thickness of the first and second end portions of each of the floor underlayment sheets comprise about one half (½) the thickness of the middle body portion of each of the floor underlayment sheets.

32-34. (canceled)

35. The floor underlayment system as in claim 21, wherein the inner face of the first end portion of each of the floor underlayment sheets faces in a first direction and the inner face of second end portion of each of the floor underlayment sheets faces in an opposite second direction.

36. A method of making floor underlayment sheet, the method comprising:
providing a sheet of a resilient polymer;
forming a first end portion in the sheet of the resident polymer extending outward from a middle body portion of the sheet of the resilient polymer from a first side of the middle body portion, the first end portion having an outer face portion that aligns with and is contiguous with a first outer face of the middle body portion and an inner face that is opposite the first end portion outer face, the first end portion having a thickness that is a fraction of a thickness of the middle body portion; and
forming a second end portion in the sheet of the resilient polymer extending outward from the middle body portion of the sheet of the resilient polymer from a second side of the middle body portion, the second end portion having an outer face portion that aligns with and is contiguous with a second outer face of the middle body portion and an inner face that is opposite the second end portion outer face, the second end portion having a thickness that is a fraction of the thickness of the middle body portion.

37. The method according to claim 36, wherein the step of forming the first end portion in the sheet of the resilient polymer comprises cutting the sheet of the resilient polymer to form the first end portion, and the step of forming the second end portion in the sheet of the resilient polymer comprises cutting the sheet of the resilient polymer to form the second end portion.

38. The method according to claim 36, wherein the step of forming the first end portion in the sheet of the resilient polymer comprises grinding the sheet of the resilient polymer to form the first end portion, and the step of forming the second end portion in the sheet of the resilient polymer comprises grinding the sheet of the resilient polymer to form the second end portion.

39. The method according to claim 36, wherein the step of forming the first end portion in the sheet of the resilient polymer comprises sanding the sheet of the resilient polymer to form the first end portion, and the step of forming the second end portion in the sheet of the resilient polymer comprises sanding the sheet of the resilient polymer to form the second end portion.
